(19) United States
(12) Patent Application Publication
(10) Pub. No.: US 2004/0174568 A1
(43) Pub. Date: Sep. 9, 2004

(54) Image reading apparatus and image forming apparatus

(75) Inventor: Naoya Murakami, Kanagawa-ken (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/790,784

(22) Filed: Mar. 3, 2004

(30) Foreign Application Priority Data
Mar. 6, 2003 (JP) 2003-060462

(51) Int. Cl. H04N 1/409; H04N 1/58

(52) U.S. Cl. 358/2.1; 358/3.26; 358/1.13; 358/461

(57) ABSTRACT

An image reading apparatus comprises a four line CCD sensor for receiving a light reflected by a reading object and outputting either or both of a monochromatic image signal and a color image signal of R, G, and B and a correction circuit for executing shading correction for the monochromatic image signal and color image signal. The correction circuit, according to an image reading mode for the reading object or a reading state, switches a correction operation of executing the shading operation for either or both of the monochromatic image signal and color image signal of R, G, and B.

### CROSS-REFERENCE TO RELATED APPLICATIONS

This application is based upon and claims the benefit of priority from the prior Japanese Patent Application No. 2003-060462, filed on Mar. 6, 2003, the entire contents of which are incorporated herein by reference.

### BACKGROUND OF THE INVENTION

1. Field of the Invention

The present invention relates to an image reading apparatus using a four line CCD sensor outputting monochromatic image signals and color image signals of R (red), G (green), and B (blue) and to an image forming apparatus using it.

2. Description of the Related Art

In recent years, color image reading apparatuses using a color CCD are promoted in-reduction in price and speeding-up of image reading and are widely used in scanners of not only single color image reading apparatuses but also color image forming apparatuses (MFP: multi-functional peripheral).

For example, as disclosed in Japanese Patent Publication No. 2002-112046, a color CCD is mainly a three line CCD sensor reading R, G, and B and outputting RGB signals. Further, a four line CCD sensor outputting BK (black) signals in addition to RGB signals is also used. The four line CCD sensor, to speed up BK reading, uses a low-priced scanner.

An image reading apparatus using a four line CCD sensor is provided with a color CCD sensor and a monochromatic CCD sensor. When the power source for the image reading apparatus is started up, the image reading apparatus executes an initial setting operation for an amplifier amplifying image signals output from each CCD sensor and for an AD converter and executes the initial setting operation also for each CCD sensor.

For example, the image reading apparatus executes the shading correction (SHD correction) for correcting distortion of color shade of color image signals output from the color CCD sensor and the shading correction for monochromatic image signals output from the monochromatic CCD sensor and then executes image reading using each CCD sensor.

However, when the image reading apparatus executes the shading correction for color image signals and monochromatic image signals and then reads images, at the time of reading color images, the time required for the shading correction for monochromatic image signals becomes useless for reading color images and the fast (scan) copy time (the time required for reading the first image to be read) is delayed.

Similarly, at the time of reading monochromatic images, the time required for the shading correction for color image signals becomes useless for reading monochromatic images.

Further, in the automatic color selection (ACS) mode for automatically selecting and reading either or both of monochromatic images and color images, executing the shading correction beforehand for monochromatic image signals or color image signals may preferably shorten the total scan (copy) time.

On the other hand, to continuously copy monochromatic or color images, the shading correction is executed whenever the document is to be interchanged. In this case, the useless time in the scan (copy) time is prolonged, and the total scan time is increased, and a useless time interval is required.

### SUMMARY OF THE INVENTION

An object of the present invention is to provide an image reading apparatus for shortening the time required for the shading correction and realizing high efficiency and high speed of the image reading operation and an image forming apparatus using it.

The present invention provides an image reading apparatus comprising a four line CCD sensor to receive a light reflected by a reading object and output either or both of a monochromatic image signal and a color image signal of R, G, and B; and a correction circuit to execute shading correction for the monochromatic image signal and the color image signal; wherein the correction circuit switches a correction operation of executing the shading correction for either or both of the monochromatic image signal and the color image signal of R, G, and B according to an image reading mode for the reading object or a reading state.

Further, the present invention provides an image forming apparatus comprising a four line CCD sensor to receive a light reflected by a reading object and outputting either or both of a monochromatic image signal and a color image signal of R, G, and B; a correction circuit, according to an image reading mode for the reading object or a reading state, switches an operation of executing a shading correction for either or both of the monochromatic image signal and the color image signal of R, G, and B outputted from the four line CCD sensor; and an image forming unit to form an image on the basis of either or both of the monochromatic image signal and the color image signal for which the shading correction is executed by switching the operation of the correction circuit.

### BRIEF DESCRIPTION OF THE DRAWINGS

FIG. 1 is a block diagram of an image forming apparatus using the first embodiment of the image reading apparatus relating to the present invention;

FIG. 2 is a perspective view of a four line CCD sensor used in the image reading apparatus shown in FIG. 1;

FIG. 3 is an enlarged view of a light receiver of the four line CCD sensor used in the image reading apparatus shown in FIG. 2;

FIG. 4 is a graph showing spectral sensitivity characteristics of a line sensor BK constituting the four line CCD sensor used in the image reading apparatus shown in FIG. 3;

FIG. 5 is a graph showing spectral sensitivity characteristics of line sensors R, G, and B constituting the four line CCD sensor used in the image reading apparatus shown in FIG. 3;

FIG. 6 is a graph showing a spectral distribution of a xenon lamp used in the image forming apparatus shown in FIG. 1;

FIG. 7 is a block diagram of the four line CCD sensor used in the image reading apparatus shown in FIG. 2;

FIG. 8 is a chart showing signal output of the line sensors BK, R, G, and B of the four line CCD sensor used in the image reading apparatus shown in FIG. 7;

FIG. 9 is a chart showing output signals of the line sensor BK of the four line CCD sensor used in the image reading apparatus shown in FIG. 7;

FIG. 10 is a timing chart for explaining realization of high-speed reading of the four line CCD sensor used in the image reading apparatus shown in FIG. 7;

FIG. 11 is a block diagram for realizing four times of the reading speed of the four line CCD sensor used in the image reading apparatus;

FIG. 12 is an operation timing chart for realizing four times of the reading speed of the four line CCD sensor used in the image reading apparatus shown in FIG. 11;

FIG. 13 is a block diagram of the image processor of the image reading apparatus shown in FIG. 1;

FIG. 14 is a flow chart in the monochromatic reading mode of the image reading apparatus;

FIG. 15 is a flow chart in the color reading mode of the image reading apparatus;

FIG. 16 is a flow chart in the automatic color selection (ACS) mode of the image reading apparatus;

FIG. 17 is a flow chart in the continuous mode of the image reading apparatus; and

FIG. 18 is a block diagram showing the second embodiment of the image reading apparatus relating to the present invention.

### DETAILED DESCRIPTION OF THE INVENTION

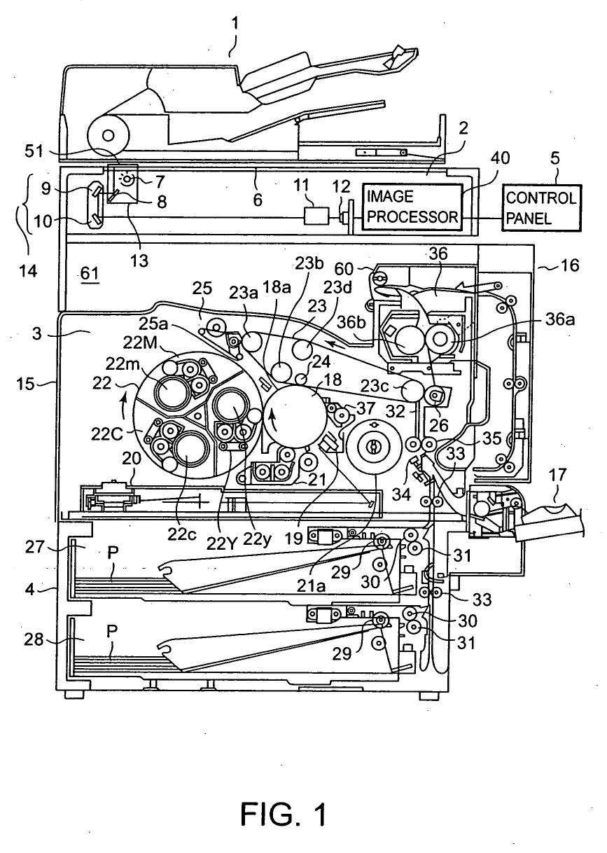

The first embodiment of the present invention will be explained below with reference to the accompanying drawings. 10 FIG. 1 is a block diagram of an image forming apparatus using the image reading apparatus of the present invention. The image forming apparatus comprises an automatic document feeder (ADF) 1, a scanner 2 as an image reading unit, a process unit 3 forming an output image, a paper supply unit 4, and a control panel 5.

Scanner 2 illuminates a reading object such as a document (a reading object) supplied from ADF 1 and a document set on a document table with light from a light source. Scanner 2 leads reflected light from the document to a four line CCD sensor via an optical member such as a mirror and a lens. The reflected light led to the four line CCD sensor is photoelectrically converted to produce image data. This image data is outputted to process unit 3, an external apparatus not shown in the drawing, and a network to produce images.

A document to be read by scanner 2 moves on a platen glass 6 at a fixed speed by ADF 1 or is put on platen glass 6 upside down. The document is illuminated by a light source 7 and the reflected light from the document is focused on a four line CCD sensor 12 via mirrors 8 to 10 and a reduction lens 11.

When reading the document put on platen glass 6, a first carriage 13 composed of light source 7 and mirror 8 and a second carriage 14 composed of mirrors 9 and 10 move on the drawing from the right to the left by a drive motor not shown in the drawing. By doing this, the document is scanned by illumination light from light source 7 (in the sub-scanning direction).

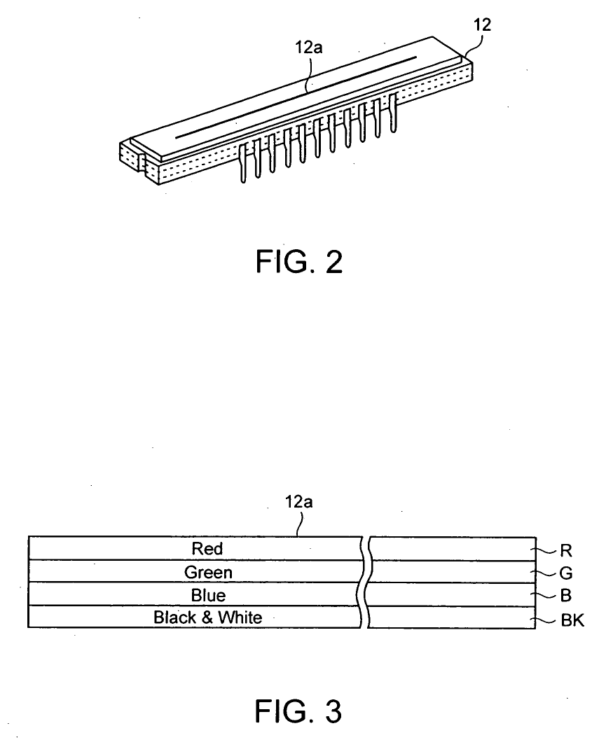

The moving speed of first carriage 13 is two times of the moving speed of second carriage 14 and the optical path length from the document to four line CCD sensor 12 is always made constant. When the document is to be conveyed by ADF 1, light irradiated from light source 7 does not move and the document moves to be scanned. FIG. 2 is an external view of four line CCD sensor 12 and FIG. 3 is an enlarged view of a light receiver 12a of four line CCD sensor 12. Light receiver 12a of four line CCD sensor 12 includes a line sensor BK having no arranged optical filter, a line sensor R having an arranged optical filter realizing sensitivity to red, a line sensor G having an arranged optical filter realizing sensitivity to green, and a line sensor B having an arranged optical filter realizing sensitivity to blue side by side. The line sensors BK, R, G, and B respectively have, for example, photodiodes in correspondence to 7500 pixels at a pitch of 4.7 μm as light receiving elements.

As mentioned above, four line CCD sensor 12 has the four lines of line sensors BK, R, G, and B arranged side by side, so that images read by each line sensor are shifted in the sub-scanning direction.

When reading color images, it is general to hold read image information by the line memory and correct the displacement. Further, when the carriage moving speed and document moving speed in the sub-scanning direction are uneven (jittered), they cannot be perfectly corrected always.

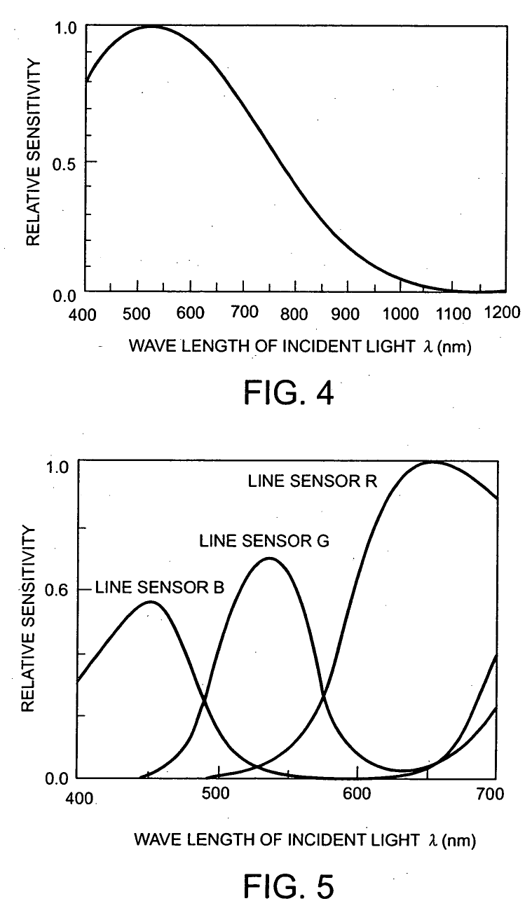

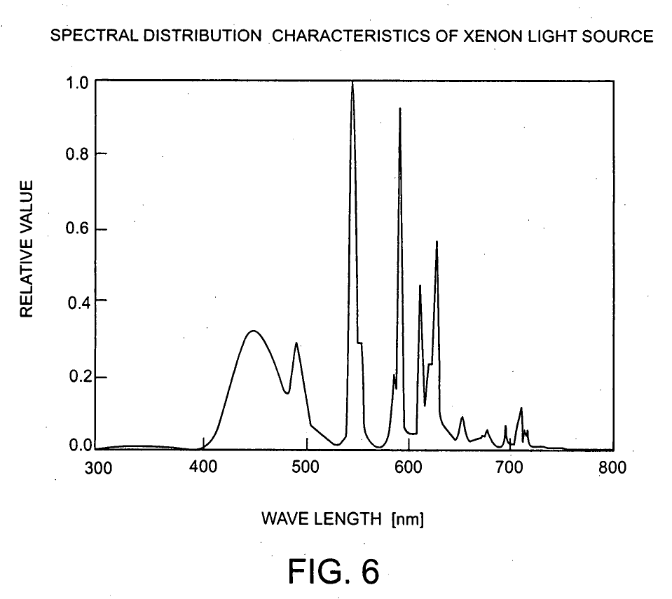

The characteristics of four line CCD sensor 12 will be explained below. FIG. 4 shows the spectral sensitivity characteristics of line sensor BK constituting four line CCD sensor 12. FIG. 5 shows the spectral sensitivity characteristics of line sensors R, G, and B constituting four line CCD sensor 12 and FIG. 6 shows the spectral distribution of the xenon lamp of light source 7.

As shown in FIG. 6, the light irradiated from the xenon lamp of light source 7 has wave lengths (spectrum) from about 400 nm to 730 nm. A case that the light from light source 7 is reflected from a white document and enters four line CCD sensor 12 will be considered.

As shown in FIGS. 4 and 5, line sensors R, G, and B are sensitive only to the wave lengths in the characteristic zones. On the other hand, in consideration of that line sensor BK is sensitive to the wave length zone from less than 400 nm to more than 1000 nm and the light quantities are reduced by the optical filters of the R, G, and B colors, it is clear that signals outputted from line sensor BK are larger than signals from line sensors R, G, and B. Namely, line sensor BK is of higher sensitivity than line sensors R, G, and B.

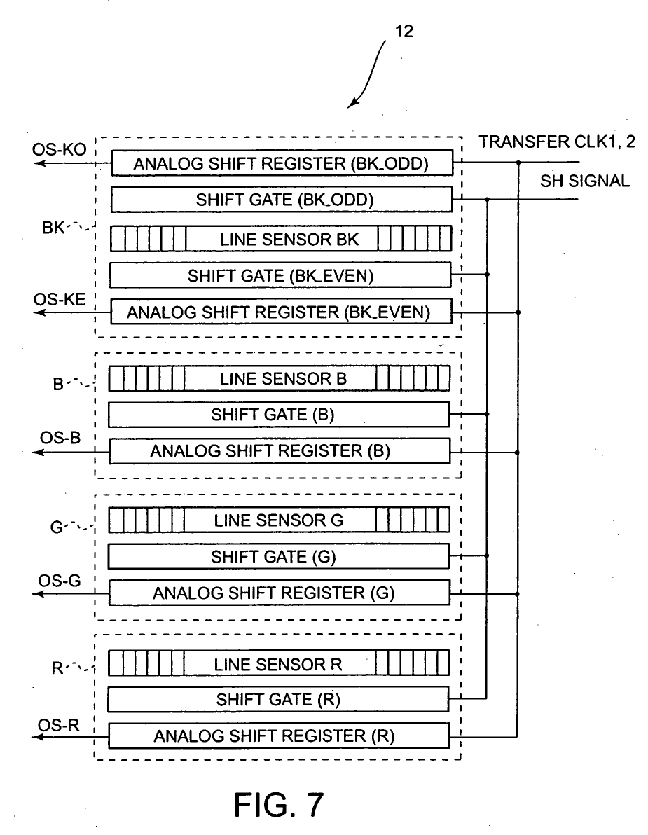

FIG. 7 shows a block diagram of four line CCD sensor 12. The constitution of line sensor BK is partially different from the constitution of each of line sensors R, G, and B.

When light is irradiated to line sensors R, G, and B, the light receiving elements constituting line sensors R, G, and B generate charges for each pixel according to the irradiation light quantity and irradiation time. When an SH signal is input to the respective shift gates, charges corresponding to the respective pixels are supplied to analog shift registers via the shift gates. The analog shift registers serially output charges (image information) corresponding to the pixels from line sensors R, G, and B in synchronization with transfer clocks CLK1 and CLK2.

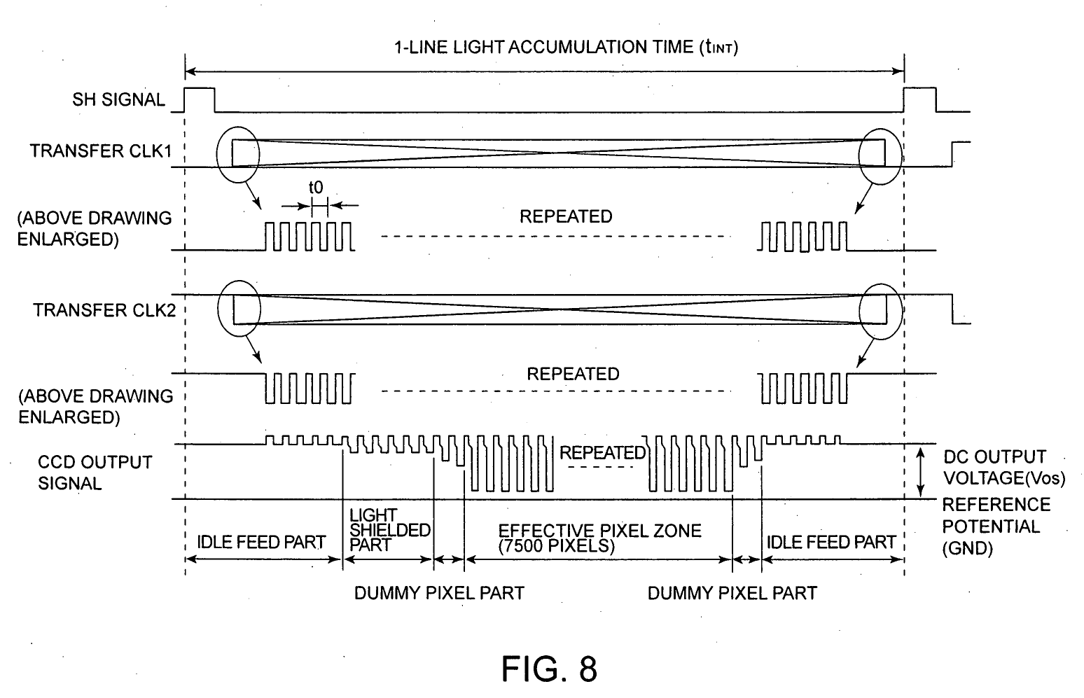

Signal output of line sensors BK, R, G, and B will be explained by referring to FIG. 8. Line sensors BK, R, G, and B are provided with light shielded pixel parts that the light receiving elements are shielded against light by an aluminum sheet so as to prevent light from entering the pre-stage of 7500 effective pixels, dummy pixel parts, and idle feed parts.

To transfer all output signals of line sensors BK, R, G, and B to the outside, transfer clocks more than those in correspondence to 7500 pixels are required. Here, assuming the total of the light shielded pixel parts, dummy pixel parts, and idle feed parts as that in correspondence to 500 pixels, transfer clocks in correspondence to 800 pixels are required. The time is an important factor for deciding the light accumulation time (tINT) per line.

Namely, the light receiving elements in respective line sensors BK, R, G, and B, during the light accumulation time (tINT) per line, generate charges according to the reflected light from the document to input an SH signal, so that the line sensors continuously repeat an operation that the charges are transferred to the analog shift registers and during the next light accumulation time (tINT), signals are output to the outside in synchronization with the transfer clocks.

Next, line sensor BK will be explained. The basic operation is the same as that,of line sensors R, G, and B, though as shown in FIG. 7, it is characterized in that line sensor BK has two sets of shift gates and analog shift registers. When light is irradiated to line sensor BK, the light receiving elements constituting line sensor BK generate charges according to the irradiation light quantity and irradiation time per each pixel. When the SH signal is input to a shift gate BK_EVEN, via the respective shift gates, the charges corresponding to the odd pixels are supplied to an analog shift register BK_ODD and the charges corresponding to the even pixels are supplied to an analog shift register BK_EVEN. The analog shift registers, in synchronization with the transfer clocks CLK1, and CLK2, respectively output serially charges (image information) corresponding to the odd pixels and even pixels.

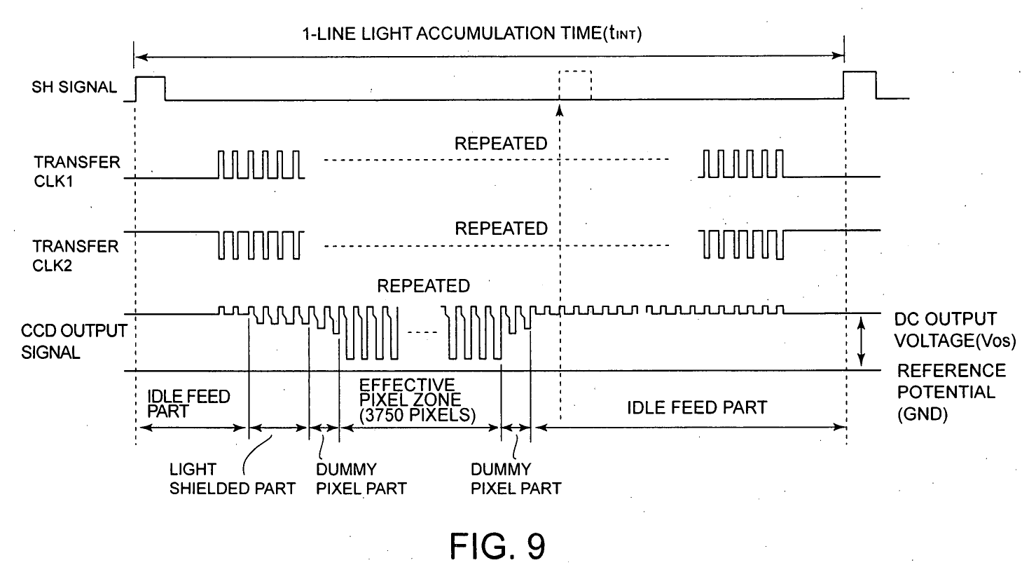

An output signal of line sensor BK will be explained by referring to FIG. 9. Similarly to line sensors R, G, and B, line sensor BK is also provided with light shielded pixel parts that the light receiving elements are shielded against light by an aluminum sheet so as to prevent light from entering the pre-stage of 7500 effective pixels, dummy pixel parts, and idle feed parts. The total of the light shielded pixel parts, dummy pixel parts, and idle feed parts is correspondent to 500 pixels.

In line sensor BK, as mentioned above, charges are transferred in two ways in correspondence to odd pixels and even pixels, so that the number of transfer clocks necessary to serially output charges (image information) in correspondence to 8000 pixels may be that in correspondence to 4000 pixels.

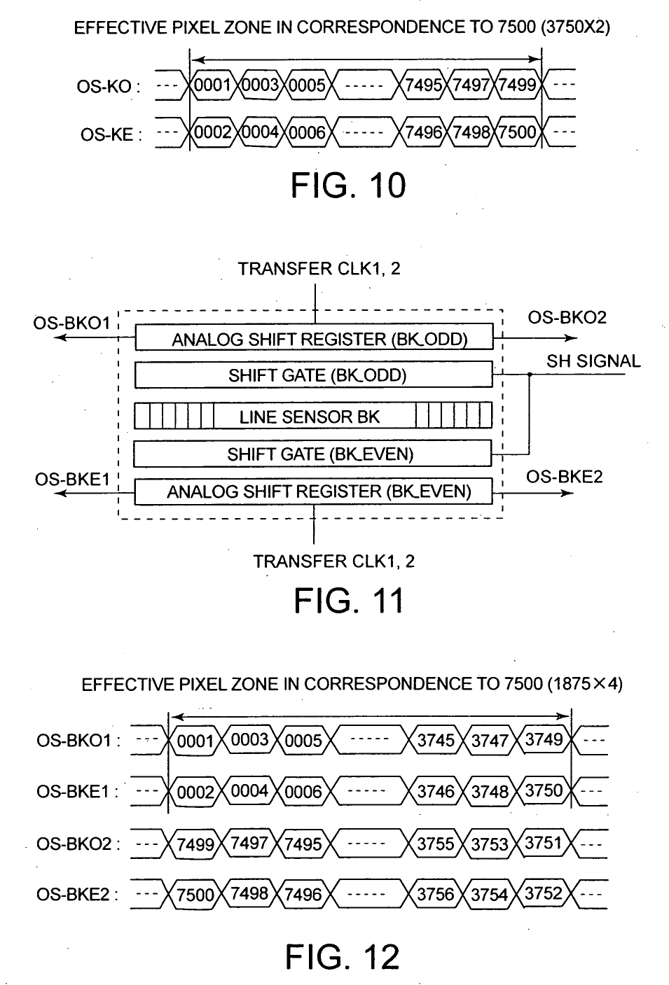

Therefore, the cycle of the SH signal inputted to the shift gates can be shortened and the light accumulation time (tINT) per line can be shortened. As mentioned above, line sensor BK is of high sensitivity, so that there is no problem imposed even if the light accumulation time (tINT) per line is shortened. FIG. 10 shows by dotted lines that the cycle of the SH signal can be shortened and shows that the effective pixel zone corresponds to 3750 pixels and signals respectively corresponding to odd pixels and even pixels are separately output from the analog shift registers.

In four line CCD sensor 12, when line sensor BK is used as mentioned above, it is explained that the reading speed two times of that of line sensors R, G, and B can be realized. Further, when the sensitivity of line sensor BK is much enough to spare, the reading speed can be increased more. FIGS. 11 and 12 show a block diagram and an operation timing chart that the output of line sensor BK is divided into two parts of odd pixels and even pixels and moreover is divided into two parts of the output in the former half and the output in the latter half to realize the four-times reading speed.

The constitution of the image forming apparatus will be explained below by referring to FIG. 1 again. Process unit 3 outputs an image on the basis of image data read from the document by scanner 2 or image data inputted from an external apparatus not shown in the drawing onto paper (transfer medium) P. Paper supply unit 4 supplies paper P to process unit 3.

Scanner 2, process unit 3, and paper supply unit 4 are stored in a main body 15. On the right of main body 15, a double unit 16 and a manual paper supply unit 17 are attached removably. Double unit 16 turns over paper P on one side of which an image is formed by process unit 3 and supplies the sheer of paper again to process unit 3. Manual paper supply unit 17 manually supplies paper P to process unit 3.

Process unit 3 has a photosensitive drum (an image carrying member) 18 extending in the front-rear direction (the direction of the drawing surface) of the apparatus. In the rotational direction (the direction of the arrow shown in the drawing) of photosensitive drum 18, a main charger 19, an exposure 20, a black developing unit (second developing unit) 21, a revolver (developing unit) 22, an intermediate transfer belt (intermediate transfer device) 23, and a drum cleaner (cleaning device) 37 are installed.

Main charger 19 charges a peripheral surface 18a of photosensitive drum 18 (hereinafter, referred to as a drum surface) at a predetermined potential.

Exposure 20 is arranged in the neighborhood of the lower end of process unit 3 and exposes drum surface 18a charged at the predetermined potential with a scanning laser beam to form an electrostatic latent image of each color on drum surface 18a.

Black developing unit 21 is arranged between photosensitive drum 18 and exposure 20, that is, opposite to photosensitive drum 18 from underneath. Black developing unit 21 supplies a black developer to the electrostatic latent image for black formed on drum surface 18a by exposure 20 to develop and forms a black developer on drum surface 18a. Black developing unit 21 is installed movably so as to separate the developing roller from or make it contact with drum surface 18a. When forming a black image, the developing roller moves in contact with drum surface 18a and when forming other color images, the developing roller is kept away from drum surface 18a. Further, to black developing unit 21, a developer is supplied from a toner cartridge 21a.

Revolver 22 is rotatably installed in the neighborhood of the left of photosensitive drum 18 in the drawing. Revolver 22 has a yellow developing unit (first developing unit) 22Y, a magenta developing unit (second developing unit) 22M, and a cyan developing unit (third developing unit) 22C. Developing units 22Y, 22M, and 22C are removably stored in revolver 22 arranged in the rotational direction of revolver 22.

Further, developing units 22Y, 22M, and 22C have toner cartridges 22y, 22m, and 22c storing respective color developers. When forming an image, revolver 22 rotates clockwise and desired developing units 22Y, 22M, and 22C are selectively arranged on drum surface 18a of photosensitive drum 18 opposite to it.

In the developing units built in process unit 3 like this, only black developing unit 21 is arranged independently and yellow developing unit 22Y, magenta developing unit 22M, and cyan developing unit 22C are arranged within revolver 22.

By use of such a constitution, when forming yellow, magenta, and cyan images, an operation of rotating revolver 22 is required, while when forming a black image, black developing unit 21 may be just brought close to drum surface 18a. Therefore, the apparatus is structured so that the time required to enable image forming is shorter in black than that in other colors.

Intermediate transfer belt 23 is arranged in such a position that it makes contact with photosensitive drum 18 from above. Intermediate transfer belt 23 is hung over a drive roller 23a, a pre-transfer roller 23b, a transferring roller 23c, and a tension roller 23d respectively having revolving shafts extending in the front-rear direction (the direction of the drawing surface). Inside intermediate transfer belt 23, a primary transfer roller 24 is installed to press intermediate transfer belt 23 to drum surface 18a at a predetermined pressure and to transfer a developer image formed on drum surface 18a to intermediate transfer belt 23.

Around intermediate transfer belt 23, a belt cleaner 25 for cleaning intermediate transfer belt 23 and a secondary transfer roller 26 for transferring the developer image on intermediate transfer belt 23 to paper P are respectively installed separatably from the surface of intermediate transfer belt 23.

Paper supply unit 4 has two paper supply cassettes 27 and 28. At the upper right ends of paper supply cassettes 27 and 28 shown in the drawing, pick-up rollers 29 are respectively installed to pick up the sheets of paper P at the uppermost ends stored in the cassettes. At the positions neighboring the downstream side in the paper picking-up direction by the pick-up rollers 29, a feed-out roller 30 and a separation roller 31 are respectively arranged in contact with each other.

At the positions neighboring the right of paper supply cassettes 27 and 28 shown in the drawing, a paper conveying path 32 opposite to the secondary transfer point where intermediate transfer belt 23 and secondary transfer roller 26 are in contact with each other is installed. On paper conveying path 32, a plurality of conveying roller pairs 33 rotating with paper P held, an aligning sensor 34 detecting arrival of paper P, and an aligning roller pair 35 for supplying paper P to the secondary transfer point at a predetermined timing are sequentially installed.

On paper conveying path 32 extending upward through the secondary transfer point, a fixing unit 36 for heating, pressurizing, and fixing the developer transferred onto paper P is installed. Fixing unit 36 has a heating roller 36a having a built-in heater and a pressurizing roller 36b for pressing heating roller 36a.

Control panel 5 has a copy start button and a plurality of selection switches for selecting, as a mode for reading a document, a monochromatic reading mode to read monochromatic images, a color reading mode to read color images, an automatic color selection (ACS) mode for automatically selecting and reading either or both of monochromatic images and color images, and a continuous mode for continuously scanning a plurality of reading objects to read automatically either or both of monochromatic images and color images.

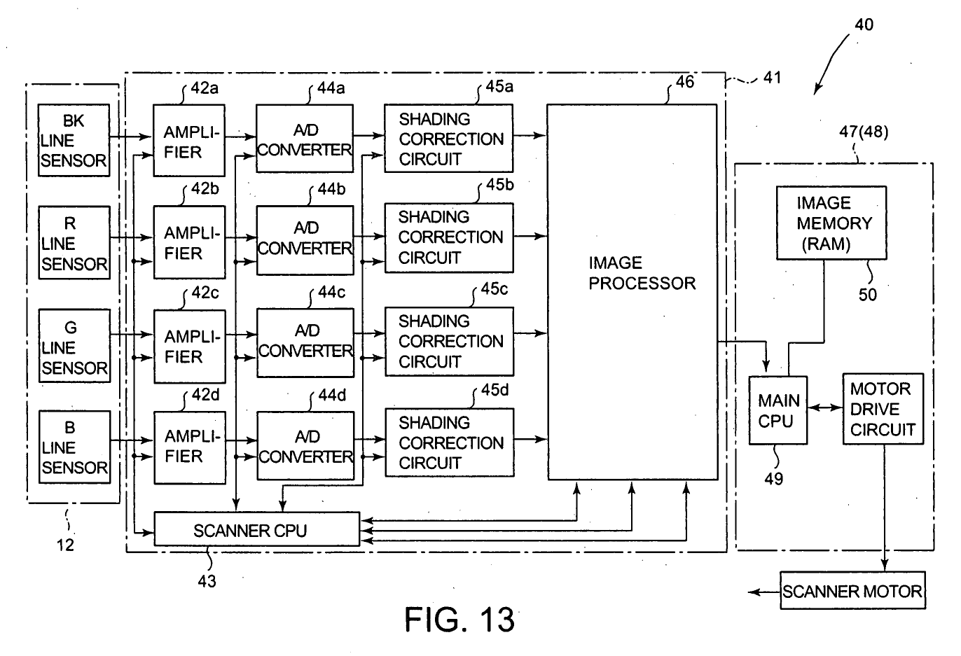

FIG. 13 is a schematic block diagram for explaining an example of an image processor 40 for processing either or both of a monochromatic image signal and a color image signal of R, G, and B outputted from four line CCD sensor 12 and generating an output image signal for image forming by the image forming apparatus shown in FIG. 1.

Four line CCD sensor 12 outputs a monochromatic image signal and a color image signal at the same time. Line sensors BK, R, G, and B of four line CCD sensor 12 are respectively connected to amplifiers 42a, 42b, 42c, and 42d of an image signal processor 41. Amplifiers 42a, 42b, 42c, and 42d amplify monochromatic image signals or color image signals of R, G, and B which are respectively outputted from line sensors BK, R, G, and B up to a predetermined level under the control of a scanner CPU 43.

To the output terminals of amplifiers 42a, 42b, 42c, and 42d, A/D converters 44a, 44b, 44c, and 44d are respectively connected. A/D converters 44a, 44b, 44c, and 44d convert monochromatic image signals and color image signals of R, G, and B outputted from line sensors BK, R, G, and B which are amplified by amplifiers 42a, 42b, 42c, and 42d to digital signals.

To the output terminals of A/D converters 44a, 44b, 44c, and 44d, shading correction circuits 45a, 45b, 45c, and 45d are respectively connected. Shading correction circuits 45a, 45b, 45c, and 45d correct the reference values on the white level and black level for digital signals outputted from A/D converters 44a, 44b, 44c, and 44d according to a threshold level predetermined on the basis of the reflected light from the white reference plate. Among shading correction circuits 45a, 45b, 45c, and 45d, shading correction circuits 45b, 45c, and 45d of R, G, and B are connected to an image processor 46.

Image processor 46 corrects the displacement of the document reading position (at the same time) in the sub-scanning direction when the document is read by line sensors R, G, and B under the control of scanner CPU 43 for the output signals of shading correction circuits 45a, 45b, 45c, and 45d, corrects the effect of color aberration given according to the color component due to the arrangement of line sensors BK, R, and B and reduction lens 11, executes, for example, color correction (changing of the color balance) and concentration correction for a monochromatic signal and a color image signal from line sensor BK, and outputs an image signal.

Further, the output image signal outputted from image processor 46, under the control of main CPU 43 of a main controller board 48 of an image forming apparatus 47, is held by, for example, an image memory (RAM) or a buffer memory 50.

Scanner CPU 43, upon selection of the monochromatic reading mode, color reading mode, automatic color selection (ACS) mode, or continuous mode by control panel 5, selects and controls shading correction circuits 45a, 45b, 45c, and 45d for executing the shading correction for correcting the distortion of color shade according to the selected mode.

Scanner CPU 43 selects and controls shading correction circuits 45a, 45b, 45c, and 45d when power is turned on, when monochromatic or color images are started to read, when a document is continuously read, when monochromatic images or color images are automatically switched to read, and when the adjustment mode is selected.

The adjustment mode is a mode which changes scanner 2 into the state of adjusting the parameter for RGB reading position correction of image processor 46, RGB color aberration correction, color correction, and density correction.

Scanner CPU 43, in the monochromatic reading mode, operates shading correction circuit 45a for executing the shading correction for a monochromatic image signal outputted from four line CCD sensor 12 and does not operate shading correction circuits 45b to 45d for executing the shading correction for a color image signal.

Scanner CPU 43, in the color reading mode, operates shading correction circuits 45b to 45d for executing the shading correction for a color image signal outputted from four line CCD sensor 12 and does not operate shading correction circuit 45a for executing the shading correction for a monochromatic image signal.

Scanner CPU 43, in the automatic color selection (ACS) mode, operates shading correction circuits 45a to 45d for executing the shading correction for both a monochromatic image signal and a color image signal outputted from four line CCD sensor 12.

Scanner CPU 43, in the continuous mode, operates shading correction circuits 45a to 45d in order to execute the shading correction on the white level for a color image signal outputted from four line CCD sensor 12.

Next, the operation of the apparatus constituted as mentioned above will be explained.

When copying image information of a reading object (a document), the object (document) is placed on platen glass 6 at a predetermined position.

When power is turned on, and the copy start button is operated from control panel 5, and the monochromatic reading mode, color reading mode, automatic color selection (ACS) mode, or continuous mode is instructed, light source 7 is turned on and amplifiers 42a to 42d, A/D converters 44a to 44d, shading correction circuits 45a to 45d, and the motor are initialized.

Next, the shading correction is executed by shading correction circuits 45a to 45d. Namely, a first carriage 13 is moved under a white reference plate 51 and here, light emitted from light source 7 is irradiated to white reference plate 51. The reflected light from white reference plate 51 is reflected by a mirror 8 fixed to first carriage 13 toward a second carriage 14, additionally reflected by mirrors 9 and 10 of second carriage 14, and enters reduction lens 11.

The light entering reduction lens 11 is focused on light receiver 12aof four line CCD sensor 12. The ???light focused on four line CCD sensor 12 is photoelectrically converted sequentially by four line sensors R, G, and B corresponding to, for example, R, G, and BK images which are complementary colors of C, M, and Y and outputted at a predetermined timing.

A monochromatic image signal outputted from the BK line sensor of four line CCD sensor 12 and color image signals outputted from the R line sensor, G line sensor, and B line sensor are respectively input to amplifiers 42a to 42d of image signal processor 41 and are amplified up to a predetermined level under the control of scanner CPU 43.

The output signals from the BK line sensor and R, G, and B line sensors which are amplified by amplifiers 42a to 42d are respectively converted to digital signals by A/D converters 44a to 44d and are input to shading correction circuits 45a to 45d.

When the fast copy time is given priority at the time of turning on-power, the shading correction is executed for a monochromatic image signal and a color image signal outputted from four line CCC sensor 12. Namely, shading correction circuits 45a to 45d respectively store digital monochromatic image signals and digital color image signals from the BK line sensor and R, G, and B line sensors when the shading correction circuits receive the reflected light from white reference plate 51 (white reference).

Next, light source 7 is turned off and in this state, similarly to the aforementioned white shading operation, the digital signals of the monochromatic image signal outputted from the BK line sensor of four line CCD sensor 12 and the color image signals outputted from the R, G, and B line sensors are stored in shading correction circuits 45a to 45d (black reference).

The shading correction executes the normalization indicated in the following formula on the basis of the black reference and white reference which are pre-read and corrects uneven intensity of illumination of image data and element variations.

I=k·(S−K)/(W·K) (1)

where k indicates a coefficient, S image data before correction, K the black reference (stored in the black memory), and W the white reference (stored in the white memory).

Further, when the time from start-up of the power source to ready is given priority, it is unknown which is selected, the monochromatic reading mode or the color reading mode, so that for monochromatic image signals and color image signals outputted from four line CCD sensor 12, the shading operation is not performed.

However, since the shading operation must be performed at the time of copy start, to shorten the time required for the shading operation, only the black shading operation is performed.

On the other hand, at the time of copying image information of a document, when the document is put on a predetermined position of platen glass 6 and the copy start button and the selection switch for the document reading mode are operated on control panel 5, similarly to the aforementioned, light source 7 is turned on and amplifiers 42a to 42d, A/D converters 44a to 44d, shading correction circuits 45a to 45d, and the motor are initialized. Hereafter, the shading operation is performed according to the monochromatic reading mode, color reading mode, automatic color selection (ACS) mode, or continuous mode which is operated on control panel 5.

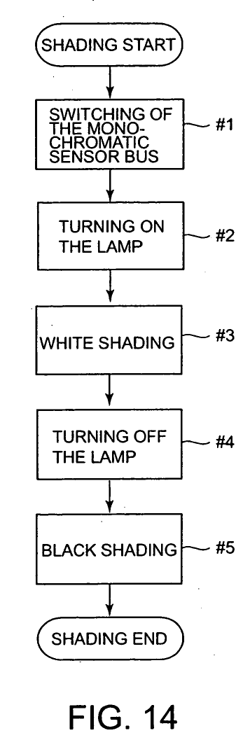

Firstly, the shading operation when the monochromatic reading mode is selected on control panel 5 will be explained by referring to the flow chart in the monochromatic reading mode shown in FIG. 14.

Firstly, when scanner CPU 43 reads that the monochromatic reading mode is selected from control panel 5, at Step #1, it switches the bus to the BK line sensor (monochromatic), operates shading correction circuit 45a for executing the shading correction for a monochromatic image signal outputted from four line CCD sensor 12, and does not operate shading correction circuits 45b to 45d for executing the shading correction for a color image signal.

Next, light source 7 is turned on at Step #2 and then at Step #3, the same white shading operation as the aforementioned is executed. Namely, first carriage 13 is moved under white reference plate 51 and here, light emitted from light source 7 is irradiated to white reference plate 51. The reflected light from white reference plate 51 enters reduction lens 11 via first and second carriages 13 and 14 and is focused on light receiver 12a of four line CCD sensor 12. And, only monochromatic image signals (white reference) outputted from four line CCD sensor 12 are stored in shading correction circuit 45a.

Next, light source 7 is turned off at Step #4 and then at Step #5, the black shading operation is executed similarly to the aforementioned. Namely, monochromatic image signals (black reference) outputted from the BK line sensor of four line CCD sensor 12 are stored in shading correction circuits 45a to 45d.

Next, the document reading operation is performed.

Light source 7 illuminates an object which is set on platen glass 6. An image light which is a reflected light from the illuminated object is reflected by mirror 8, mirror 9 and 10, passed through reduction lens 11 and focused on light receiver 12a of four line CCD sensor 12.

The light focused on four line CCD sensor 12 is photoelectrically converted sequentially by four line sensors R, G, and B corresponding to R, G, and BK images and outputted at a predetermined timing.

A monochromatic image signal outputted from the BK line sensor of four line CCD sensor 12 and color image signals outputted from the R line sensor, G line sensor, and B line sensor are respectively input to amplifiers 42a to 42d of image signal processor 41 and are amplified up to a predetermined level under the control of scanner CPU 43.

The output signals from the BK line sensor and R, G, and B line sensors which are amplified by amplifiers 42a to 42d are respectively converted to digital signals by A/D converters 44a to 44d and are input to shading correction circuits 45a to 45d. Here, when the monochromatic reading mode is selected from control panel 5, scanner CPU 43 operates shading correction circuit 45a for executing the shading correction for a monochromatic image signal outputted from four line CCD sensor 12 and does not operate shading correction circuits 45b to 45d for executing the shading correction for a color image signal. By doing this, shading correction circuit 45a executes the normalization indicated in Formula (1) described above on the basis of the black reference and white reference, which are pre-read, as a shading correction.

When a plurality of documents are to be continuously read in the monochromatic reading mode, to read the first document, similarly to the aforementioned, the white reference and black reference are stored in shading correction circuit 45a and the shading correction is executed on the basis of the black reference and white reference.

When reading the second and subsequent documents, only the white reference is stored in shading correction circuit 45a and the shading correction is executed on the basis of only the white reference.

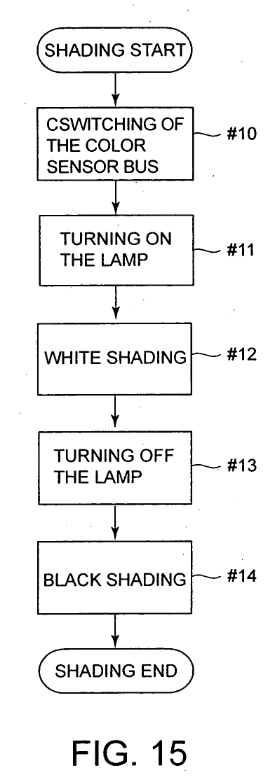

Next, the shading operation when the color reading mode is selected on control panel 5 will be explained by referring to the flow chart in the color reading mode shown in FIG. 15.

Firstly, when scanner CPU 43 reads that the color reading mode is selected from control panel 5, at Step #10, it switches the bus to the R, G, and B line sensors (color), operates shading correction circuits 45b to 45d for executing the shading correction for a color image signal outputted from four line CCD sensor 12, and does not operate shading correction circuit 45s for executing the shading correction for a monochromatic image signal.

Next, light source 7 is turned on at Step #11 and then at Step #12, the same white shading operation as the aforementioned is executed. Namely, first carriage 13 is moved under white reference plate 51 and here, light emitted from light source 7 is irradiated to white reference plate 51. The reflected light from white reference plate 51 enters reduction lens 11 via first and second carriages 13 and 14 and is focused on light receiver 12a of four line CCD sensor 12. And, only color image signals (white reference) outputted from four line CCD sensor 12 are stored in shading correction circuits 45b to 45d.

Next, light source 7 is turned off at Step #13 and then at Step #14, the black shading operation is executed similarly to the aforementioned and only color image signals (black reference) outputted from four line CCD sensor 12 are stored in shading correction circuits 45a to 45d.

Next, the document reading operation is performed.

By doing this, shading correction circuits 45b to 45d, which executes color correction of color signal, executes the normalization indicated in Formula (1) described above on the basis of the black reference and white reference, which are pre-read, as a shading correction.

When a plurality of documents are to be continuously read in the color reading mode, to read the first document, similarly to the aforementioned, the white reference and black reference are stored in shading correction circuits 45b to 45d and the shading correction is executed on the basis of the black reference and white reference.

When reading the second and subsequent documents, only the white reference is stored in shading correction circuits 45b to 45d and the shading correction is executed on the basis of only the white reference.

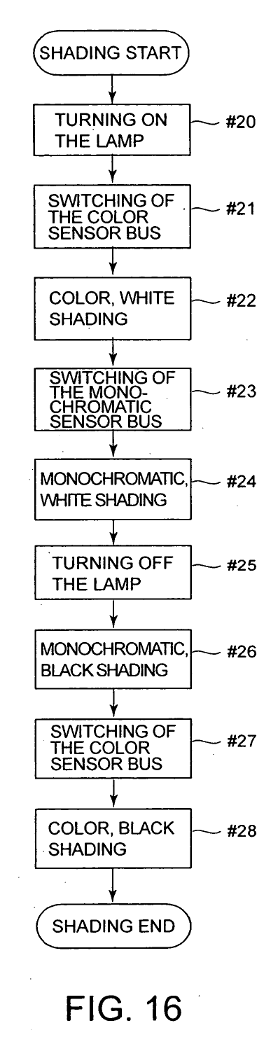

Next, the shading operation when the automatic color selection (ACS) mode is selected on control panel 5 will be explained by referring to the flow chart in the automatic color selection mode shown in FIG. 16.

Firstly, light source 7 is turned on at Step #20.

Next, when scanner CPU 43 reads that the automatic color selection (ACS) mode is selected from control panel 5, at Step #21, it switches the bus to the R, G, and B line sensors and operates shading correction circuits 45b to 45d.

Next, at Step #22, similarly to the aforementioned, the white shading operation is executed via shading correction circuits of R, G, and B 45b to 45d (the white reference for R, G, and B is stored).

Next, scanner CPU 43, at Step #23, switches the bus to the BK line sensor and operates shading correction circuit 45a.

Next, at Step #24, similarly to the aforementioned, the white shading operation is executed via shading correction circuit of BK 45a (the white reference for monochromatic color is stored).

Next, light source 7 is turned off at Step #25 and then at Step #26, similarly to the aforementioned, the black shading operation is executed via shading correction circuit of BK 45a (the black reference for monochromatic color is stored).

Next, scanner CPU 43, at Step #27, switches the bus to the R, G, and B line sensors and operates shading correction circuits 45b to 45d.

Next, at Step #28, similarly to the aforementioned, the black shading operation is executed via shading correction circuits of R, G, and B 45b to 45d (the black reference for R, G, and B is stored).

When the automatic color selection (ACS) reading mode is selected like this, it is unknown whether the document is monochromatic or colored, so that the shading operation is executed for both the BK line sensor and R, G, and B line sensors.

Next, in the automatic color selection (ACS) reading mode, the document reading operation is performed.

The document is pre-scanned and the automatic color selection (ACS) decision is executed. As a result of the decision, when the document is monochromatic, shading correction circuit 45a executes the shading correction.

When the document is colored, shading correction circuits 45b to 45d execute the shading correction.

When a plurality of documents are to be continuously read in the automatic color selection (ACS) reading mode, to read the first document, the automatic color selection (ACS) decision is executed for the first document. As a result of the decision, when the document is monochromatic, shading correction circuit 45a executes the shading correction on the basis of the black reference and white reference which are pre-stored. And, it reads the first document.

When the first document is colored, shading correction circuits 45b to 45d execute the shading correction on the basis of only the pre-stored white reference.

Then, to read the second document, the automatic color selection (ACS) decision is executed for the second document. As a result of the decision, when the document is monochromatic, similarly to the aforementioned, shading correction circuit 45a executes the shading correction on the basis of the black reference and white reference which are pre-stored. And, it reads the second document.

When the second document is colored, similarly to the aforementioned, shading correction circuits 45b to 45d execute the shading correction on the basis of only the pre-stored white reference.

To read the third and subsequent documents, the automatic color selection (ACS) decision is executed for each concerned document. As a result of the decision, when the document is monochromatic, similarly to the aforementioned, shading correction circuit 45a executes the shading correction on the basis of the black reference and white reference which are pre-stored. And, it reads the third and subsequent documents.

When the concerned document is colored, similarly to the aforementioned, shading correction circuits 45b to 45d execute the shading correction on the basis of only the pre-stored white reference. And, it reads the concerned document.

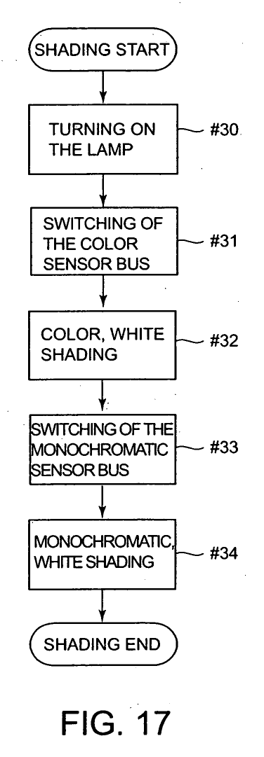

FIG. 17 shows a flow chart of the shading operation when the continuous mode is selected on control panel 5.

When copying the first document, light source 7 is turned on, and then scanner CPU 43 switches the bus to the R, G, and B line sensors, operates shading correction circuits 45b to 45d, and similarly to the aforementioned, executes the white shading operation via shading correction circuits of R, G, and B 45b to 45d.

Next, scanner CPU 43 switches the bus to the BK line sensor, operates shading correction circuit 45a, and similarly to the aforementioned, executes the white shading operation via shading correction circuit of BK 45a.

Next, light source 7 is turned off and similarly to the aforementioned, scanner CPU 43 executes the black shading operation via shading correction circuit of BK 45a.

Next, scanner CPU 43 switches the bus to the R, G, and B line sensors, operates shading correction circuits 45b to 45d, and similarly to the aforementioned, executes the black shading operation via shading correction circuits of R, G, and B 45b to 45d.

Next, to copy the second and subsequent documents, only a white shading operation is executed before starting of reading the each of documents.

That is, when scanner CPU 43 reads that the continuous mode is selected from control panel 5, at Step #31, it switches the bus to the R, G, and B line sensors and operates shading correction circuits 45b to 45d.

Next, at Step #32, similarly to-the aforementioned, scanner CPU 43 executes the white shading operation via shading correction circuits of R, G, and B 45b to 45d.

Next, scanner CPU 43, at Step #33, switches the bus to the BK line sensor and operates shading correction circuit 45a.

Next, at Step #34, similarly to the aforementioned, scanner CPU 43 executes the white shading operation via shading correction circuits of BK 45a.

As mentioned above, during continuous copy of the second and subsequent documents when the continuous mode is selected, only the white shading operation is executed for monochromatic image signals and color image signals.

Further, when a plurality of documents are to be continuously read in the automatic color selection (ACS) reading mode, although explained in a case of pre-scanning, if pre-scanning is not to be executed, since image processing, which changes into a monochromatic image, is executed when the document is monochromatic after carrying out color reading for all document, all reading is performed in a color. Therefore, the same shading operation as the case where the color reading mode is chosen in control panel 5 is performed.

At the time of first scanning in the automatic color selection (ACS) mode, to decide whether a monochromatic image signal is outputted from four line CCD sensor 12 or a color image signal is outputted, it is necessary to always read a color image signal.

By doing this, it is possible to execute only the shading operation for a color image signal, decide in the automatic color selection (ACS) mode, and then according to the decided monochromatic image signal or color image signal, execute the shading operation in the mode to be read next.

Image processor 46 corrects the displacement of the document reading position (at the same time) in the sub-scanning direction when the document is read by line sensors R, G, and B under the control of scanner CPU 43 for the output signals of shading correction circuits 45a, 45b, 45c, and 45d, corrects the effect of color aberration given according to the color component due to the arrangement of line sensors BK, R, and B and reduction lens 11, executes, for example, color correction (changing of the color balance) and concentration correction for a monochromatic signal and a color image signal from line sensor BK, and outputs an image signal.

Further, the output image signal outputted from image processor 46, under the control of main CPU 43 of a main controller board 48 of an image forming apparatus 47, is held by, for example, an image memory (RAM) or a buffer memory 50.

When the output image signal outputted from image processor 46 is held by the image memory (RAM) or buffer memory 50 like this, the image of a reading objective is transferred onto paper P on the basis of the image signal.

Next, the operation of transferring a monochromatic image onto paper P will be explained.

The revolver rotates at the home position where all developing units 22Y, 22M, and 22C are not opposite to drum surface 18a. And, black developing unit 21 moves upward to face drum surface 18a.

Belt cleaner 25 rotates clockwise around a shaft 25a and makes contact with intermediate transfer belt 23, and secondary transferring roller 26 moves to the left in the drawing and makes contact with intermediate transfer belt 23.

Exposure 20 scans a laser beam on drum surface 18a on the basis of a monochromatic image signal, thus an electrostatic latent image of black BK is formed on drum surface 18a. Then, a black developer is supplied to the electrostatic latent image on drum surface 18a via black developing unit 21 and a black developer image is formed on drum surface 18a.

The black developer image on drum surface 18a formed in this way moves by rotation of photosensitive drum 18 and reaches the primary transfer point in contact with intermediate transfer belt 23. At the primary transfer point, a bias of reverse polarity to the potential of the black developer is given to the image via the primary transfer roller and the black developer image on drum surface 18a is transferred onto intermediate transfer belt 23.

From drum surface 18a passing the primary transfer point, a black developer remaining without being transferred is removed by drum cleaner 37 and the residual charge is simultaneously neutralized. And, to form the next electrostatic latent image of black BK, drum surface 18a is evenly charged by main charger 19.

To continuously form images of black BK, similarly to the preceding operation, a series of operations, that is, exposure→developing→transfer to intermediate transfer belt 23 is executed and the next black developer image is transferred onto intermediate transfer belt 23.

The developer image of black BK transferred onto intermediate transfer belt 23 moves by rotation of intermediate transfer belt 23 and passes the secondary transfer point between primary transfer roller 24 and secondary transfer roller 26.

At this time, paper P taken out from cassette 27 or 28 by pick-up roller 29 is position-adjusted once and then fed into the secondary transfer area at a predetermined timing.

And, a bias reverse to the potential of the black developer image is applied to it via secondary transfer roller 26 and the black developer on intermediate transfer belt 23 is transferred to paper P. When the black developer is transferred to paper P, the black developer remaining on intermediate transfer belt 23 is removed by belt cleaner 25.

Paper P to which the black developer image is transferred, thereafter, passes fixing unit 36 and is heated and pressurized, and the black developer image is fixed on paper P, and a black image is formed. Paper P on which the black image is formed like this is ejected into an ejection tray 61 via an ejection roller 60 installed on the downstream side of fixing unit 36.

Next, the operation of transferring a color image onto paper P will be explained.

Black developing unit 21 moves downward and is separated from drum surface 18a.

The revolver rotates clockwise and yellow developing unit 22Y faces drum surface 18a. Belt cleaner 25 rotates counterclockwise around shaft 25a and is separated from intermediate transfer belt 23, and secondary transfer roller 26 moves in the direction of separating from paper conveying path 32 (to the right in the drawing) and is separated from intermediate transfer belt 23.

Exposure 20 scans a laser beam on drum surface 18a on the basis of a yellow image signal, thus an electrostatic latent image for yellow is formed on drum surface 18a. Then, a yellow developer is supplied to the electrostatic latent image on drum surface 18a via yellow developing unit 22Y and a yellow developer image is formed on drum surface 18a.

The yellow developer image on drum surface 18a formed in this way moves by rotation of photosensitive drum 18 and reaches the primary transfer point in contact with intermediate transfer belt 23. At the primary transfer point, a bias of reverse polarity to the potential of the yellow developer is given to the image via the primary transfer roller and the yellow developer image on drum surface 18a is transferred onto intermediate transfer belt 23.

From drum surface 18a passing the primary transfer point, a yellow developer remaining without being transferred is removed by drum cleaner 37 and the residual charge is simultaneously neutralized. And, to form the next electrostatic latent image of magenta, drum surface 18a is evenly charged by main charger 19, and revolver 22 rotates, and magenta developing unit 22M faces drum surface 18a.

In this state, similarly to the preceding case of yellow, a series of operations, that is, exposure→developing→transfer to intermediate transfer belt 23 is executed and a magenta developer image is superimposition-transferred on the yellow developer image on intermediate transfer belt 23. After the magenta developer image is transferred like this, a cyan developer image is similarly superimposition-transferred.

And, the revolver rotates at the home position where all developing units 22Y, 22M, and 22C are not opposite to drum surface 18a. And, black developing unit 21 moves upward to face drum surface 18a. In this state, the same process as the preceding process is executed and a black developer image is transferred onto intermediate transfer belt 23 so as to be superimposition-transferred onto the yellow developer image, magenta developer image, and cyan developer image.

When all the color developer images are superimposed on intermediate transfer belt 23 like this, secondary transfer roller 26 moves to the left in the drawing and makes contact with intermediate transfer belt 23 and belt cleaner 25 makes contact with intermediate transfer belt 23. In this state, all the color developer images superimposed on intermediate transfer belt 23 move by rotation of intermediate transfer belt 23 and pass the secondary transfer point between primary transfer roller 24 and secondary transfer roller 26.

At this time, paper P taken out from cassette 27 or 28 by pick-up roller 29 is conveyed upward on vertical paper conveying path 32 by conveying roller pair 33, is position-adjusted once by aligning roller pair 35, and then is fed into the secondary transfer area at a predetermined timing.

And, a bias reverse to the potential of each color developer image is applied to it via secondary transfer roller 26 and each color developer on intermediate transfer belt 23 is transferred to paper P. When the developers are transferred to paper P, the black developer remaining on intermediate transfer belt 23 is removed by belt cleaner 25.

Paper P to which the developers of all the colors are transferred together, thereafter, passes fixing unit 36 and is heated and pressurized, and the developers of all the colors are fixed on paper P, and a color image is formed. Paper P on which the color image is formed like this is ejected into ejection tray 61 via ejection roller 60 installed on the downstream side of fixing unit 36.

As mentioned above, in the first embodiment, when four line CCD sensor 12 of a type of outputting a monochromatic image signal and a color image signal at the same time is used, the sensor switches and operates shading correction circuits 45a to 45d according to the monochromatic reading mode, color reading mode, automatic color selection (ACS) mode, or continuous mode and executes the shading correction for either or both of the monochromatic image and R, G, and B color image signals.

By doing this, in the monochromatic reading mode, color reading mode, automatic color selection (ACS) mode, or continuous mode, the reading time for each document can be shortened, and the total scanning time can be shortened, thus a wasteful time can be avoided. As a result, the time required for shading correction can be shortened and high efficiency and speed up of the image reading operation can be realized.

Next, the second embodiment of the present invention will be explained with reference to the accompanying drawings. Further, the same numerals are assigned to the same parts as those shown in FIG. 13 and detailed description therefor will be omitted.

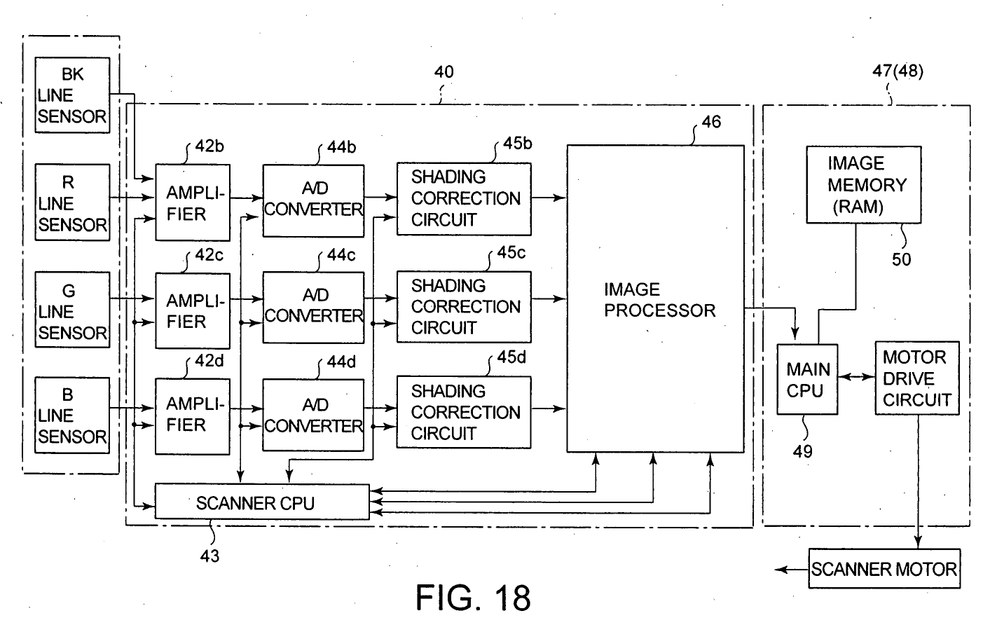

FIG. 18 is a block diagram of image processor 40. Four line CCD sensor 12 is of a type of independently outputting a monochromatic image signal or a color image signal.

Image processor 40 has amplifiers 42b to 42d, A/D converters 44b to 44d, and shading correction circuits 45b to 45d.

A monochromatic image signal outputted from the BK line sensor of four line CCD sensor 12 and a color image signal outputted from the R line sensor are input to amplifier 42b.

Namely, four line CCD sensor 12 independently outputs a monochromatic image signal or a color image signal, so that amplifier 42b, A/D converter 44b, and shading correction circuit 45b process both a monochromatic image signal outputted from the BK line sensor of four line CCD sensor 12 and a color image signal outputted from the R line sensor.

Scanner CPU 43, in the monochromatic reading mode, to execute the shading correction for a monochromatic image signal outputted from four line CCD sensor 12, operates only amplifier 42b, A/D converter 44b, and shading correction circuit 45b.

Scanner CPU 43, in the color reading mode, to execute the shading correction for color image signals of R, G, and B outputted from four line CCD sensor 12, operates amplifiers 42b to 42d, A/D converters 44b to 44d, and shading correction circuits 45b to 45d.

Further, in the monochromatic reading mode, scanner CPU 43 may feed a monochromatic image signal outputted from four line CCD sensor 12 to at least one line of the lines of amplifier 42b, A/D converter 44b, and shading correction circuit 45b, the lines of amplifier 42c, A/D converter 44c, and shading correction circuit 45c, or the lines of amplifier 42d, A/D converter 44d, and shading correction circuit 45d and may feed it to two lines or all lines.

By use of such a constitution, to copy image information of a document, when the document is put on platen glass 6 at a predetermined position and the copy start button and the selection switch for the document reading mode are operated on control panel 5, similarly to the aforementioned, light source 7 is turned on and amplifiers 42a to 42d, A/D converters 44a to 44d, shading correction circuits 45a to 45d, and the motor are initialized. Hereafter, the shading operation is performed according to the monochromatic reading mode, color reading mode, automatic color selection (ACS) mode, or continuous mode which is operated on control panel 5.

This shading operation, since a monochromatic image signal and a color image signal are not superimposition-outputted from four line CCD sensor 12, can use amplifier 42b, A/D converter 44b, and shading correction circuit 45b in common for a monochromatic image signal and a color image signal.

Therefore, in the monochromatic reading mode, the bus is switched to the BK line sensor (monochromatic) and by the operations of amplifier 42b, A/D converter 44b, and shading correction circuit 45b, image signals of white obtained by using white reference plate 51 and black obtained when light source 7 is turned off are stored in shading correction circuit 45b.

In the color reading mode, the bus is switched to the line sensors of R, G, and B and by the operations of amplifiers 42b to 42d, A/D converters 44b to 44d, and shading correction circuits 45b to 45d, image signals of white and black are stored in shading correction circuits 45b to 45d.

Further, in the automatic color selection (ACS) mode, scanner CPU 43 operates amplifiers 42b to 42d, A/D converters 44b to 44d, and shading correction circuits 45b to 45d and stores color image signals of R, G, and B outputted from four line CCD sensor 12 when white reference plate 51 is used and when light source 7 is turned off in shading correction circuits 45b to 45d.

When the decision result of automatic color selection (ACS) obtained by reading an image using the R, G, and B line sensors is a color image, white and black reference signals obtained when white reference plate 51 is used and when light source 7 is turned off are not stored in shading correction circuits 45b to 45d, and the images of the documents are continuously read, and color image signals outputted from the R, G, and B line sensors are subject to the shading correction by shading correction circuits 45b to 45d and fed to image processor 46.

As mentioned above, there is no need to store a color image signal as a reference for each document in shading correction circuits 45b to 45d, so that the time required for copying can be shortened.

On the other hand, when the decision result of automatic color selection (ACS) is a monochromatic image, scanner CPU 43 operates only amplifier 42b, A/D converter 44b, and shading correction circuit 45b and stores monochromatic image signals outputted from four line CCD sensor 12 when white reference plate 51 is used and when light source 7 is turned off in shading correction circuit 45b.

When the image of a document is to be read, a monochromatic image signal outputted from the BK line sensor is subject to the shading correction by shading correction circuit 45b and fed to image processor 46.

When the reading of monochromatic images ends, scanner CPU 43 operates again amplifiers 42b to 42d, A/D converters 44b to 44d, and shading correction circuits 45b to 45d and stores color image signals of R, G, and B outputted from four line CCD sensor 12 when white reference plate 51 is used and when light source 7 is turned off in shading correction circuits 45b to 45d.

By doing this, the next image reading in the automatic color selection (ACS) mode can be speeded up.

Further, when a state which is to be started up as default when power is turned on, a color image or a monochromatic image is decided, it is desirable to switch to use of either of a monochromatic image signal and a color image signal outputted from four line CCD sensor 12 and execute the shading correction according to the switched monochromatic image signal or color image signal.

For example, even if four line CCD sensor 12 is of a type of independently outputting a monochromatic image signal or a color image signal, the concerned correction circuit is switched to shading correction circuit 45b or each of shading correction circuits 45b to 45d according to the operation state of outputting either of a monochromatic image signal and a color image signal, thus document reading of improved productivity can be executed.

Further, the present invention is not limited to the first and second embodiments mentioned above and at the execution stage, within a range which is not deviated from the object of the present invention, it can be modified variously.

For example, with respect to four line CCD sensor 12, the one having four arranged line sensors BK, R, G, and B is explained. However, four line CCD sensor 12 is not limited to it and for example, a one having two black line sensors BK is available.

As described above in detail, according to the present invention, an image reading apparatus for shortening the time required for the shading correction and realizing high efficiency and high speed of the image reading operation and an image forming apparatus using it can be provided.

What is claimed is:

1. An image reading apparatus comprising:
a four line CCD sensor to receive a light reflected by a reading object and output either or both of a monochromatic image signal and a color image signal of R, G, and B; and
a correction circuit to execute shading correction for the monochromatic image signal and the color image signal;
wherein the correction circuit switches a correction operation of executing the shading correction for either or both of the monochromatic image signal and the color image signal of R, G, and B according to an image reading mode for the reading object or a reading state.

2. The image reading apparatus according to claim 1, wherein said image reading mode includes at least one mode of a reading of the monochromatic image from the reading object, a reading of the color image from the reading object, an automatically selecting and reading either or both of the monochromatic image and the color image from the reading object, and an continuously and automatically reading either or both of monochromatic images and color images from a plurality of the reading objects.

3. The image reading apparatus according to claim 1, wherein the reading state includes at least one of the time of turning on power, the start time of the image reading, the time of continuously reading the reading objects but before starting reading each of the reading objects, the time of automatically switching reading of the monochromatic image or the color image, and the time of adjustment mode.

4. The image reading apparatus according to claim 1, wherein the four line CCD sensor is of a type of outputting the monochromatic image signal and the color image signal at the same time and there are a plurality of the correction circuits and each of the correction circuits executes the shading correction for the monochromatic image signal and the color image signal of R, G, and B.

5. The image reading apparatus according to claim 1, wherein the four line CCD sensor is of a type of independently outputting the monochromatic image signal and the color image signal and the correction circuit executes the shading correction by sharing either of the monochromatic image signal and the color image signal.

6. The image reading apparatus according to claim 1, wherein the correction circuit, in a reading mode to read the monochromatic image, switches to an operation of executing the shading correction for the monochromatic image signal outputted from the four line CCD sensor and not executing the shading correction for the color image signal.

7. The image reading apparatus according to claim 1, wherein the correction circuit, in a reading mode to read the color image, switches to an operation of not executing the shading correction for the monochromatic image signal outputted from the four line CCD sensor and executing the shading correction for the color image signal.

8. The image reading apparatus according to claim 1, wherein the correction circuit, in a mode of automatically selecting and reading either or both of the monochromatic image and the color image, switches to an operation of executing the shading correction for both the monochromatic image signal and the color image signal outputted from the four line CCD sensor.

9. The image reading apparatus according to claim 1, wherein the correction circuit, in a mode of continuously reading a plurality of the reading objects, switches to an operation of executing the shading correction on the white level for the color image signal outputted from the four line CCD sensor.

10. An image forming apparatus comprising:
a four line CCD sensor to receive a light reflected by a reading object and outputting either or both of a monochromatic image signal and a color image signal of R, G, and B;
a correction circuit, according to an image reading mode for the reading object or a reading state, switches an operation of executing a shading correction for either or both of the monochromatic image signal and the color image signal of R, G, and B outputted from the four line CCD sensor; and
an image forming unit to form an image on the basis of either or both of the monochromatic image signal and the color image signal for which the shading correction is executed by switching the operation of the correction circuit.
